(19) United States
(12) Patent Application Publication
(10) Pub. No.: US 2026/0066982 A1
(43) Pub. Date: Mar. 5, 2026

(54) BEAM LINK SWITCH CONFIGURATION FOR MULTIPLE BEAM LINK SWITCH TYPES

(71) Applicant: QUALCOMM Incorporated, San Diego, CA (US)

(72) Inventors: Qing LI, Princeton Junction, NJ (US); Linhai HE, San Diego, CA (US); Yan ZHOU, San Diego, CA (US); Ozcan OZTURK, San Diego, CA (US)

(21) Appl. No.: 18/816,874

(22) Filed: Aug. 27, 2024

(51) Int. Cl. H04B 7/08; H04W 74/0833

(52) U.S. Cl. CPC H04B 7/088; H04W 74/0833

(57) ABSTRACT

Various aspects of the present disclosure generally relate to wireless communication. In some aspects, a user equipment (UE) may receive a beam link switch configuration that indicates one or more beam link switch parameters associated with a plurality of beam link switch types. The UE may transmit, based at least in part on one or more beam link switch types of the plurality of beam link switch types, a beam link switch indication. Numerous other aspects are described.

### FIELD OF THE DISCLOSURE

Aspects of the present disclosure generally relate to wireless communication and specifically relate to techniques, apparatuses, and methods for a beam link switch configuration for multiple beam link switch types.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to cause the UE to receive a beam link switch configuration that indicates one or more beam link switch parameters associated with a plurality of beam link switch types. The one or more processors may be configured to cause the UE to transmit, based at least in part on one or more beam link switch types of the plurality of beam link switch types, a beam link switch indication.

Some aspects described herein relate to an apparatus for wireless communication at a network node. The apparatus may include one or more memories and one or more processors coupled to the one or more memories. The one or more processors may be configured to cause the network node to transmit a beam link switch configuration that indicates one or more beam link switch parameters associated with a plurality of beam link switch types. The one or more processors may be configured to cause the network node to receive, based at least in part on one or more beam link switch types of the plurality of beam link switch types, a beam link switch indication.

Some aspects described herein relate to a method of wireless communication performed by a UE. The method may include receiving a beam link switch configuration that indicates one or more beam link switch parameters associated with a plurality of beam link switch types. The method may include transmitting, based at least in part on one or more beam link switch types of the plurality of beam link switch types, a beam link switch indication.

Some aspects described herein relate to a method of wireless communication performed by a network node. The method may include transmitting a beam link switch configuration that indicates one or more beam link switch parameters associated with a plurality of beam link switch types. The method may include receiving, based at least in part on one or more beam link switch types of the plurality of beam link switch types, a beam link switch indication.

Some aspects described herein relate to a non-transitory computer-readable medium that stores a set of instructions for wireless communication by a UE. The set of instructions, when executed by one or more processors of the UE, may cause the UE to receive a beam link switch configuration that indicates one or more beam link switch parameters associated with a plurality of beam link switch types. The set of instructions, when executed by one or more processors of the UE, may cause the UE to transmit, based at least in part on one or more beam link switch types of the plurality of beam link switch types, a beam link switch indication.

Some aspects described herein relate to a non-transitory computer-readable medium that stores a set of instructions for wireless communication by a network node. The set of instructions, when executed by one or more processors of the network node, may cause the network node to transmit a beam link switch configuration that indicates one or more beam link switch parameters associated with a plurality of beam link switch types. The set of instructions, when executed by one or more processors of the network node, may cause the network node to receive, based at least in part on one or more beam link switch types of the plurality of beam link switch types, a beam link switch indication.

Some aspects described herein relate to an apparatus for wireless communication. The apparatus may include means for receiving a beam link switch configuration that indicates one or more beam link switch parameters associated with a plurality of beam link switch types. The apparatus may include means for transmitting, based at least in part on one or more beam link switch types of the plurality of beam link switch types, a beam link switch indication.

Some aspects described herein relate to an apparatus for wireless communication. The apparatus may include means for transmitting a beam link switch configuration that indicates one or more beam link switch parameters associated with a plurality of beam link switch types. The apparatus may include means for receiving, based at least in part on one or more beam link switch types of the plurality of beam link switch types, a beam link switch indication.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIGS. 4A-4C are diagrams illustrating examples associated with beam link management, in accordance with the present disclosure.

FIG. 5 is a diagram illustrating an example associated with signaling for a unified framework for beam link management, in accordance with the present disclosure.

FIG. 6 is a diagram illustrating an example associated with artificial intelligence or machine learning (AI/ML) prediction, in accordance with the present disclosure.

FIG. 7 is a diagram illustrating an example associated with beam link switch parameter configuration, in accordance with the present disclosure.

FIGS. 8A-8C are diagrams illustrating examples associated with respective approaches for a unified framework for beam link management, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) and network node may perform various beam link management procedures to help maintain or improve communication. The beam link management procedures may involve switching between beams (e.g., switching from a relatively weak beam to a relatively strong beam). Beam link management procedures can involve intra-cell or inter-cell switching (e.g., beam switching, beam failure detection and recovery, lower-layer triggered mobility (LTM), or the like). Such beam link management procedures may be independent of each other. As such, these beam link management procedures may cause the UE to allocate memory resources and/or processing resources to performing redundant Layer 1 (L1) measurements based at least in part on respective configurations. This excessive resource usage may be exacerbated in multiple-input multiple-output (MIMO) use cases, which may invoke beam link management procedures frequently.

Various aspects relate generally to a unified beam link management procedure with a common configuration for multiple beam link switch types. Some aspects more specifically relate to a network node transmitting, and a UE receiving, a configuration that indicates one or more beam link switch parameters for the unified beam link management procedure with multiple beam link switch types. In some aspects, the UE and/or the network node may identify, based at least in part on the beam link switch parameters (e.g., using artificial intelligence or machine learning (AI/ML)), which one or more beam link switch types of the unified beam link management procedure are to be performed. In some aspects, the UE may transmit, to the network node, an indication of one or more beam link switch types to be performed. In some aspects, the UE and the network node may determine and perform the unified beam link management procedure with a beam switch type, based at least in part on the indication of one or more beam link switch types.

Particular aspects of the subject matter described in this disclosure can be implemented to realize one or more of the following potential advantages. In some examples, by conducting the unified beam link management procedure, the described techniques can be used to optimize beam link management. For example, the unified beam link management procedure may enable the UE or the network node to predict and determine a best beam link switch type of the multiple beam link switch types, based at least in part on the beam link switch parameters (e.g., using AI/ML). Thus, the beam link switch of the unified beam link management procedure may improve efficiency of intra-cell and/or inter-cell beam link management (e.g., make-before-break beam link switch, beam link switch with reduced latency, in MIMO use cases, or the like). As a result, the described techniques can be used to conserve memory resources, processing resources, or the like. For example, the common configuration may enable the UE to refrain from performing redundant measurements for respective beam link management procedures. In some examples, by transmitting or receiving the indication of one or more beam link switch types, the described techniques can be used to reduce beam link management signaling or message overhead. For example, the indication of one or more beam link switch types may enable the UE to avoid frequent L1 beam measurement reports for respective beam link management procedures. Thus, the indication of one or more beam link switch types may conserve radio resources for communications.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

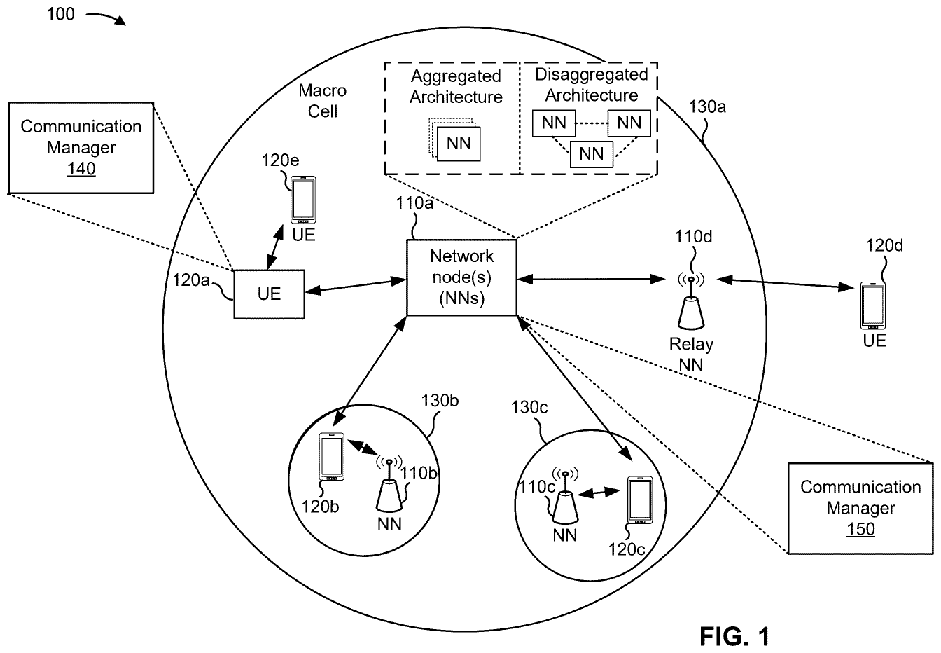

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1,FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a beam link switch configuration that indicates one or more beam link switch parameters associated with a plurality of beam link switch types; and transmit, based at least in part on one or more beam link switch types of the plurality of beam link switch types, a beam link switch indication. Additionally, or alternatively, the communication manager 140 may perform one or more other operations described herein.

In some aspects, the network node 110 may include a communication manager 150. As described in more detail elsewhere herein, the communication manager 150 may transmit a beam link switch configuration that indicates one or more beam link switch parameters associated with a plurality of beam link switch types; and receive, based at least in part on one or more beam link switch types of the plurality of beam link switch types, a beam link switch indication. Additionally, or alternatively, the communication manager 150 may perform one or more other operations described herein.

As indicated above, FIG. 1 is provided as an example. Other examples may differ from what is described with regard to FIG. 1.

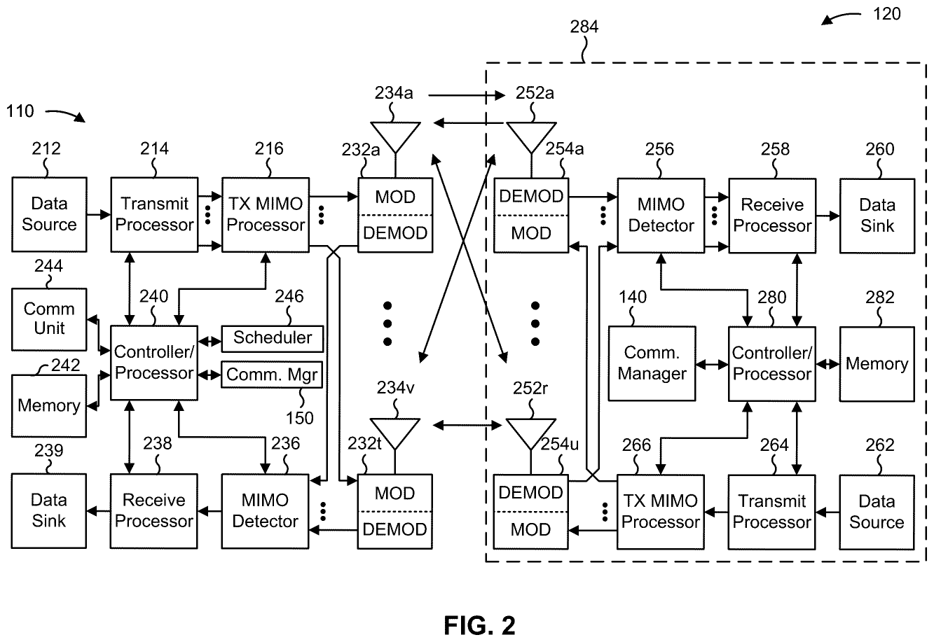

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

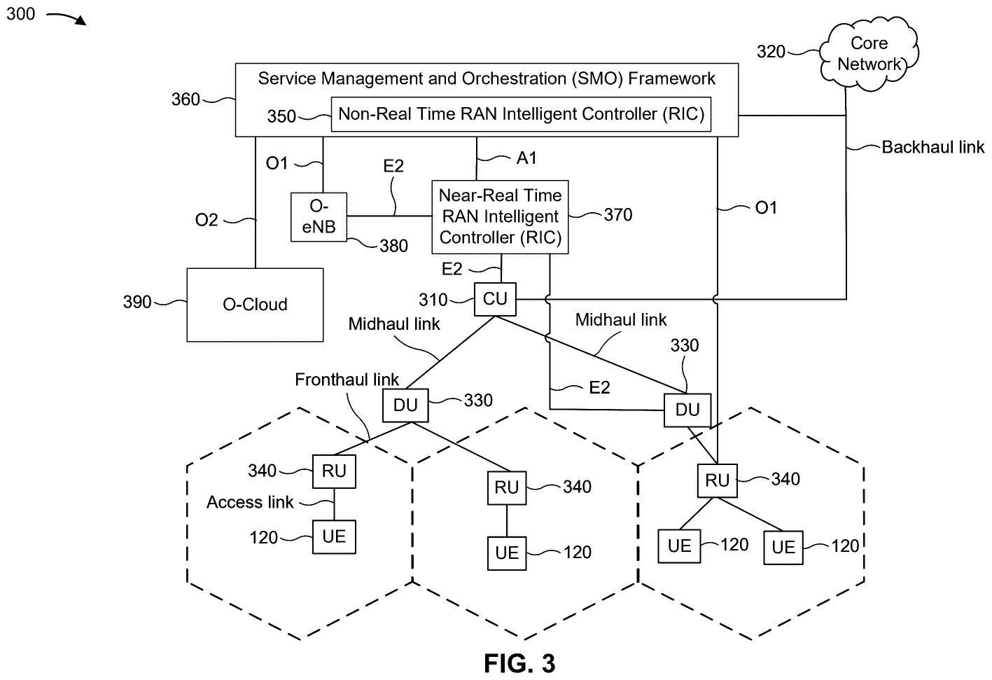

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

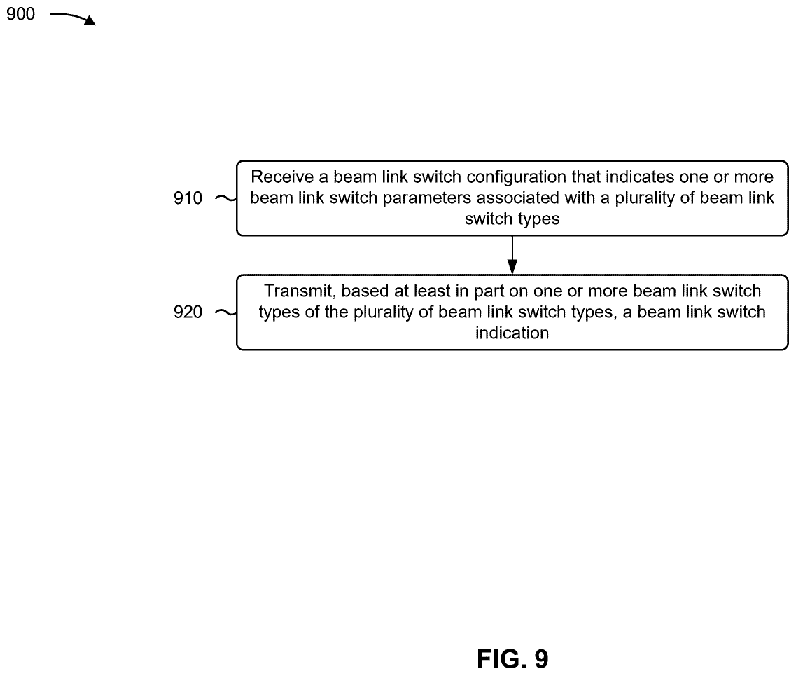

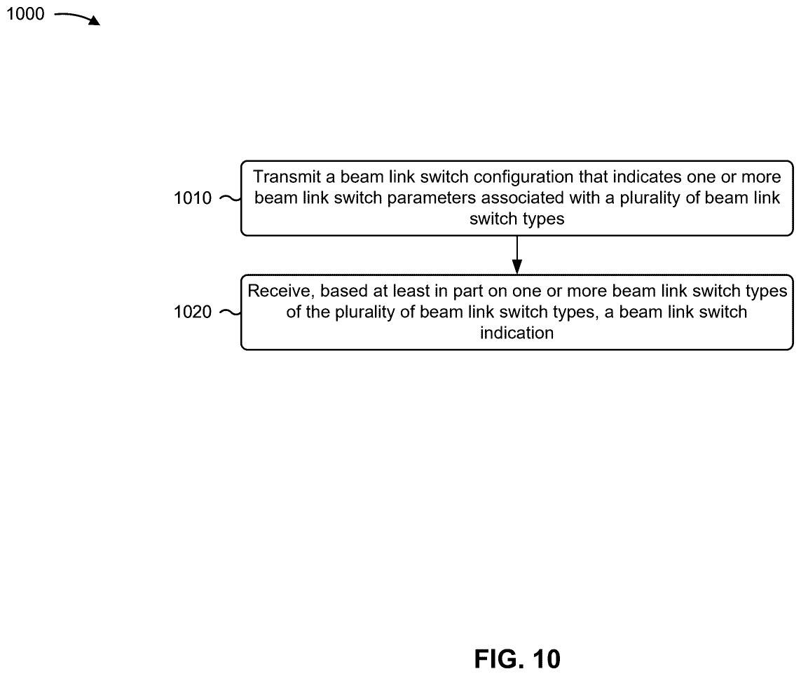

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with a beam link switch configuration for multiple beam link switch types, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving a beam link switch configuration that indicates one or more beam link switch parameters associated with a plurality of beam link switch types; and/or means for transmitting, based at least in part on one or more beam link switch types of the plurality of beam link switch types, a beam link switch indication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a beam link switch configuration that indicates one or more beam link switch parameters associated with a plurality of beam link switch types; and/or means for receiving, based at least in part on one or more beam link switch types of the plurality of beam link switch types, a beam link switch indication. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

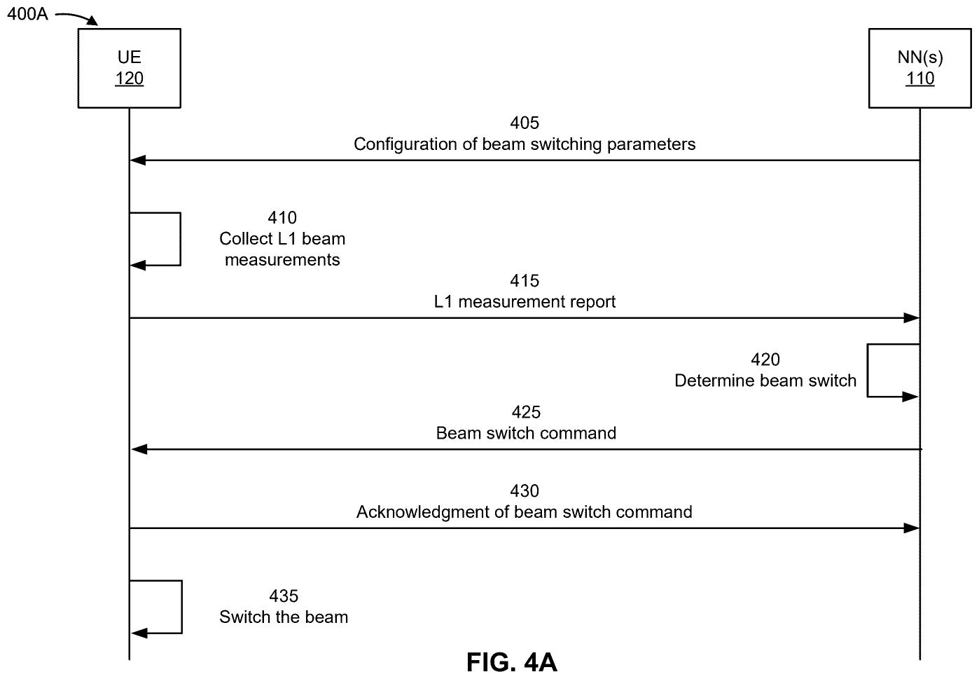

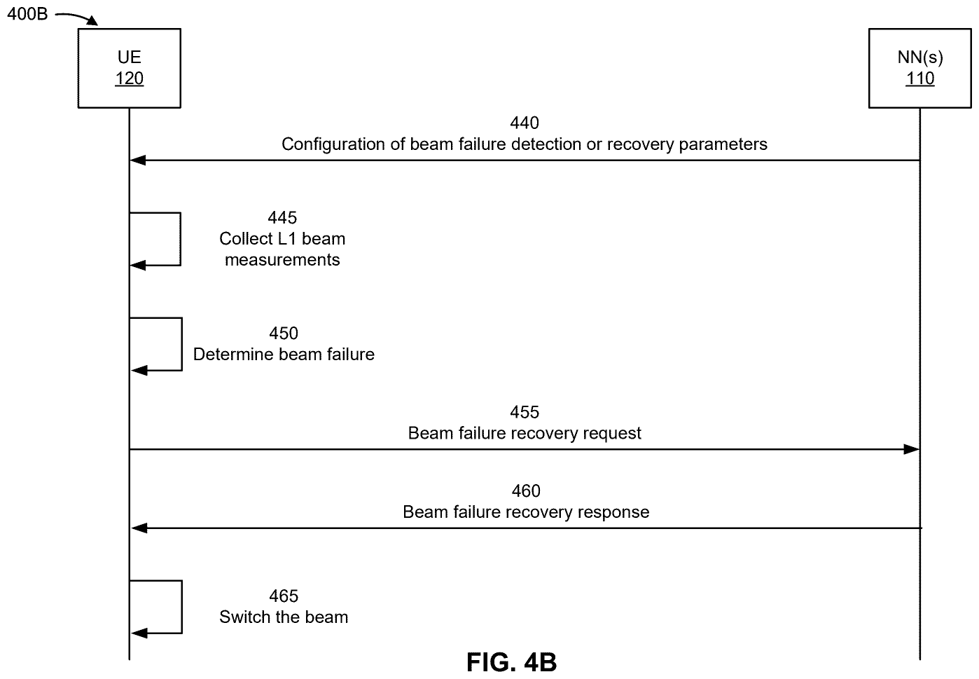

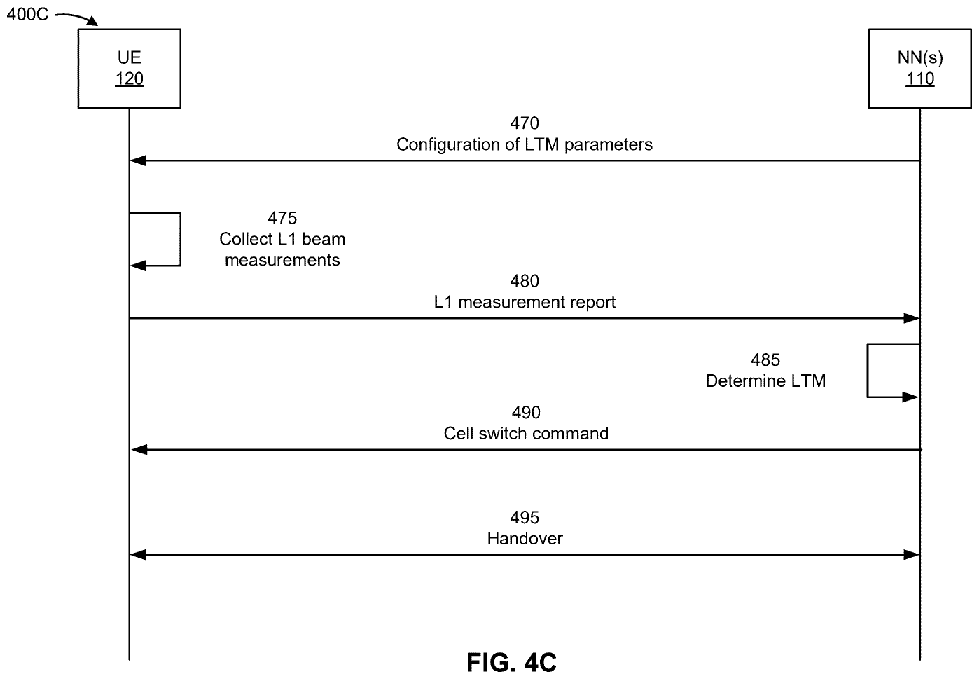

FIGS. 4A-4C are diagrams illustrating examples 400A-400C associated with beam link management, in accordance with the present disclosure. As shown in FIGS. 4A-4C, a network node 110 and a UE 120 may communicate with one another.

With reference to FIG. 4A, example 400A shows a beam switching procedure. As shown by reference number 405, the network node 110 may transmit, and the UE 120 may receive, a configuration of beam switching parameters. As shown by reference number 410, the UE 120 may collect L1 beam measurements in accordance with the beam switching parameters. As shown by reference number 415, the UE 120 may transmit, and the network node 110 may receive, an L1 measurement report of the L1 beam measurements. As shown by reference number 420, the network node 110 may determine, based at least in part on the L1 measurement report, that a beam switch is to occur. As shown by reference number 425, the network node 110 may transmit, and the UE 120 may receive, a beam switch command. As shown by reference number 430, the UE 120 may transmit, and the network node 110 may receive, an acknowledgment of the beam switch command. As shown by reference number 435, the UE 120 may switch the beam in response to the beam switch command.

With reference to FIG. 4B, example 400A shows a beam failure detection and recovery procedure. As shown by reference number 440, the network node 110 may transmit, and the UE 120 may receive, a configuration of beam failure detection or recovery parameters. As shown by reference number 445, the UE 120 may collect L1 beam measurements in accordance with the beam failure detection or recovery parameters. As shown by reference number 450, the UE 120 may determine, based at least in part on the L1 beam measurements, that a beam failure is to occur. As shown by reference number 455, the UE 120 may transmit, and the network node 110 may receive, a beam failure recovery request. As shown by reference number 460, the network node 110 may transmit, and the UE 120 may receive, a beam failure recovery response. As shown by reference number 465, the UE 120 may switch the beam in response to the beam failure recovery response.

With reference to FIG. 4C, example 400C shows a lower-layer triggered mobility (LTM) procedure. As shown by reference number 470, the network node 110 may transmit, and the UE 120 may receive, a configuration of LTM parameters. As shown by reference number 475, the UE 120 may collect L1 beam measurements in accordance with the LTM parameters. As shown by reference number 480, the UE 120 may transmit, and the network node 110 may receive, an L1 measurement report of the L1 beam measurements. As shown by reference number 485, the network node 110 may determine, based at least in part on the L1 measurement report, that LTM is to occur. As shown by reference number 490, the network node 110 may transmit, and the UE 120 may receive, cell switch command. As shown by reference number 495, the UE 120 and the network node 110 may perform a handover in response to the cell switch command. In some examples, the handover may be a random access channel (RACH)-less handover or a RACH-based handover.

The beam switching procedure of example 400A, the beam failure detection and recovery procedure of example 400B, and the LTM procedure of example 400C may be independent of each other. As such, these beam link management procedures may cause the UE 120 to allocate resources (e.g., memory resources, processing resources, bandwidth resources, or the like) to performing redundant L1 measurements based at least in part on respective configurations as shown by reference numbers 405, 440, and 470. Additionally, or alternatively, beam measurement reports (e.g., the L1 measurement report as shown by reference numbers 415 and 480) may contribute to high uplink signaling and/or message overhead associated with the beam link management procedures. Additionally, or alternatively, the beam link management procedures being independent may prevent certain optimizations between the beam link management procedures. For example, because beam link management decisions can occur independently at the network node 110 or the UE 120, the UE 120 may expend resources on performing both the beam switching procedure and the beam failure detection and recovery procedure, and/or the beam failure detection and recovery procedure and the LTM procedure, in cases where only one of those procedures would resolve beam link issues.

MIMO (e.g., 6G MIMO, which may be referred to as “mega-MIMO”) may involve deploying large quantities of antenna elements with narrow beams, which may compensate for high pathloss. Maintaining a reliable beam link connection with narrow beams is challenging, such as in cases where channel conditions change rapidly at FR2 or FR3, the direction and/or position of the UE 120 changes rapidly, or the like. Such occurrences can lead to frequent beam switches, beam failures, radio link failures, or the like. Using a large quantity of narrow beams to cover a given three-dimensional area may cause the UE 120 to monitor and report beam measurements for a large quantity of candidate beams, which may ultimately increase signaling overhead and radio resource utilization. As a result, MIMO use cases may exacerbate the issues discussed above with respect to the independent beam link management procedures.

As indicated above, FIGS. 4A-4C are provided as examples. Other examples may differ from what is described with respect to FIGS. 4A-4C.

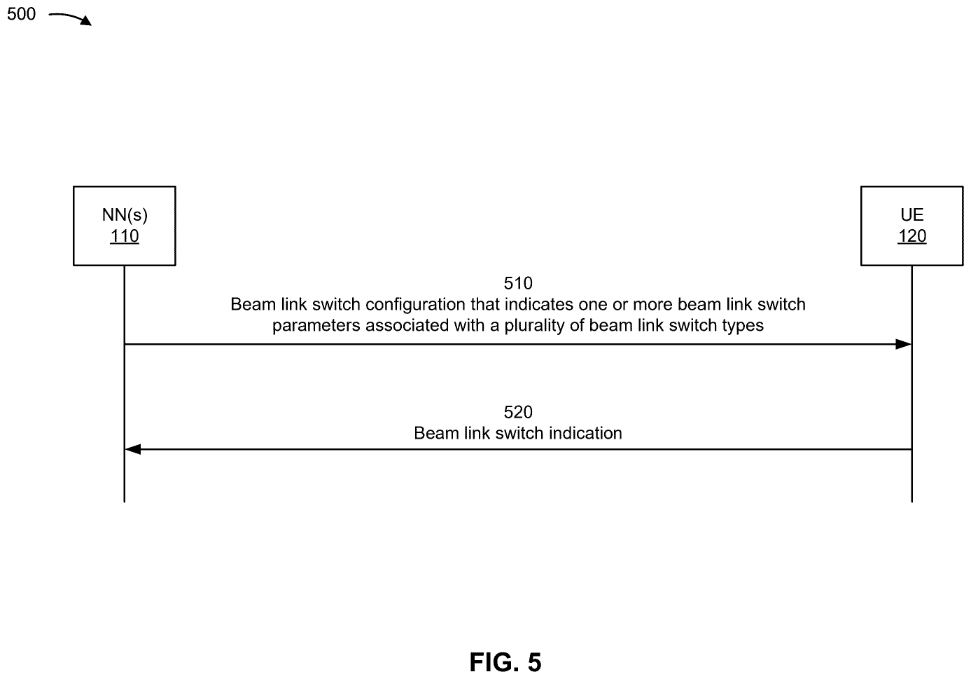

FIG. 5 is a diagram illustrating an example 500 associated with signaling for a unified framework for beam link management, in accordance with the present disclosure. As shown in FIG. 5, a network node 110 and a UE 120 may communicate with one another.

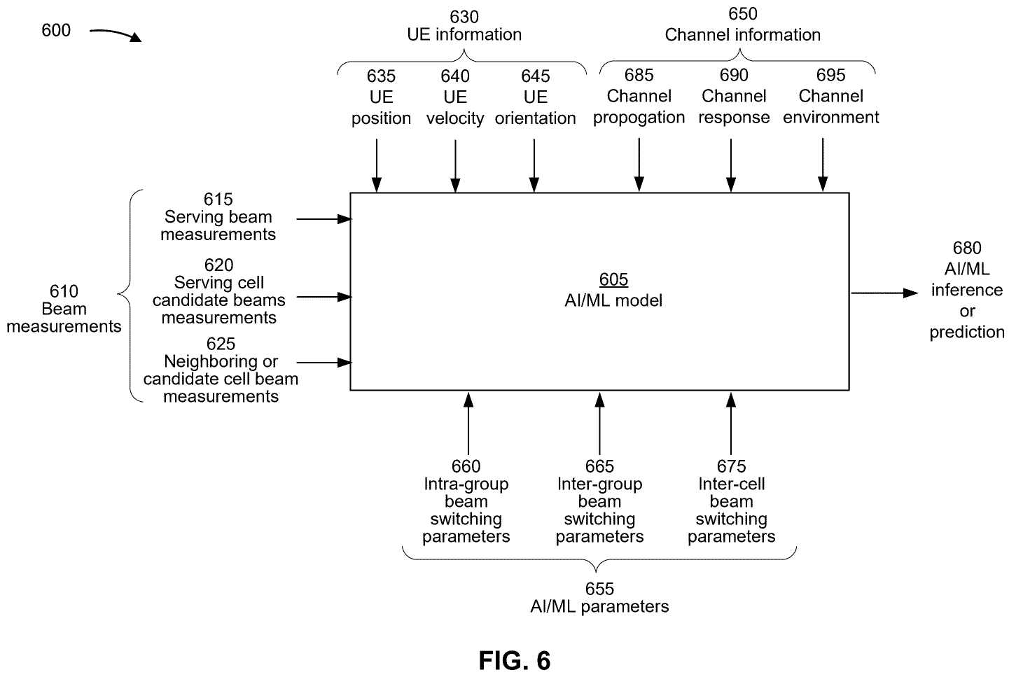

As shown by reference number 510, the network node 110 may transmit, and the UE 120 may receive, a beam link switch configuration that indicates one or more beam link switch parameters associated with a plurality of beam link switch types. A beam link switch parameter (or “beam link management parameter”) may indicate one or more parameters (e.g., one or more measurements) that the UE 120 is to perform, and/or under what circumstances (e.g., one or more conditions) the UE 120 is to transmit a beam link switch indication responsive to the beam link switch inference or prediction. Examples of beam link switch parameters are discussed below in connection with FIG. 6.

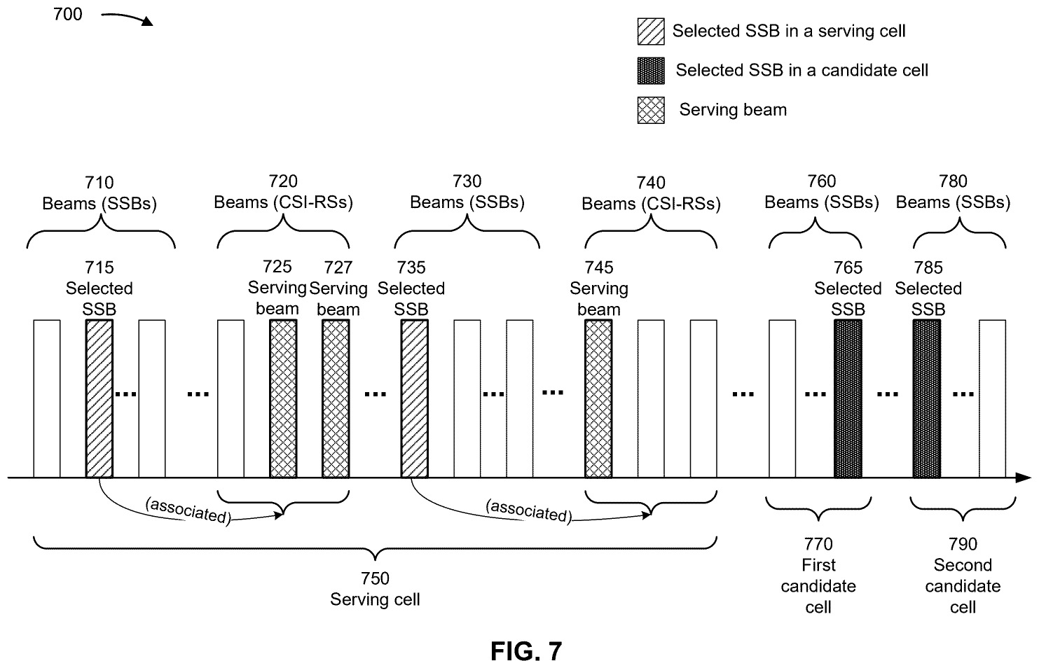

A beam link switch type may be classified based at least in part on a first beam from which the UE 120 switches and/or a second beam to which the UE 120 switches. For example, as discussed in greater detail below in connection with FIG. 7, a beam link switch type may include intra-group beam switching (e.g., beam switching within a candidate beam group based at least in part on a selected SSB, which may be referred to as intra-SSB beam link switching), inter-group beam switching (e.g., beam switching from a first candidate beam group to a second candidate beam group of a cell based at least in part on a first selected SSB and a second selected SSB, respectively, within the cell, which may be referred to as inter-SSB beam link switching), inter-cell beam switching (e.g., beam switching from a first beam of a first cell to a second beam of a second cell), or the like.

The beam link switch parameter(s) may be associated with the plurality of beam link switch types in that the beam link switch parameter(s) may be common to each beam link switch type of the plurality of beam link switch types. In this sense, the beam link switch configuration may be a common configuration for the one or more beam link switch parameters associated with a unified beam link management procedure. For example, the beam link switch parameter(s) may comprise a common beam measurement configuration for beam link switch inference or prediction, a common measurement or detection configuration of UE's position, velocity, and/or orientation for beam link switch inference or prediction, a common measurement configuration of channel condition or status for beam link inference or prediction, or the like.

In some aspects, based at least in part on a performance of the AI/ML inference (e.g., an accuracy of a prediction for efficiently switching the beam link before beam link degradation or failure, a false alarm that may trigger frequent beam link switching or “ping-ponging” between beam links or cause a delayed beam link switch after beam link degradation or failure, or the like), the network node 110 may reconfigure one or more beam link switch parameters (e.g., using an RRC message) or activate or deactivate a subset of the one or more ranges of one or more respective beam link switch parameters (e.g., using a MAC-CE or DCI with a code point of a subset of one or more ranges of one or more respective beam link switch parameters).

In some aspects, based on the network performance (e.g., throughput, latency, reliability, or the like) or system status (e.g., network loading, interference, or the like), the network node 110 may reconfigure one or more beam link switch parameters (e.g., using an RRC message) or activate or deactivate a subset of one or more ranges of one or more respective beam link switch parameters (e.g., using a MAC-CE or DCI).

In some aspects, based at least in part on the AI/ML model associated with the UE 120 and/or the AI/ML model associated with the network node 110 (e.g., AI/ML model activation or deactivation, AI/ML model update or switch, or the like), the network node 110 may reconfigure one or more beam link switch parameters (e.g., using an RRC message) or activate or deactivate a subset of one or more ranges of one or more respective beam link switch parameters (e.g., using MAC-CE or DCI).

In some examples, the UE 120 may identify one or more beam link switch types of the plurality of beam link switch types based at least in part on the one or more beam link switch parameters. For example, the UE 120 may collect measurements in accordance with the beam link switch configuration and identify that one or more beam link switches of the one or more beam link switch types are to occur, based at least in part on the AI/ML inference or prediction for the beam link switch.

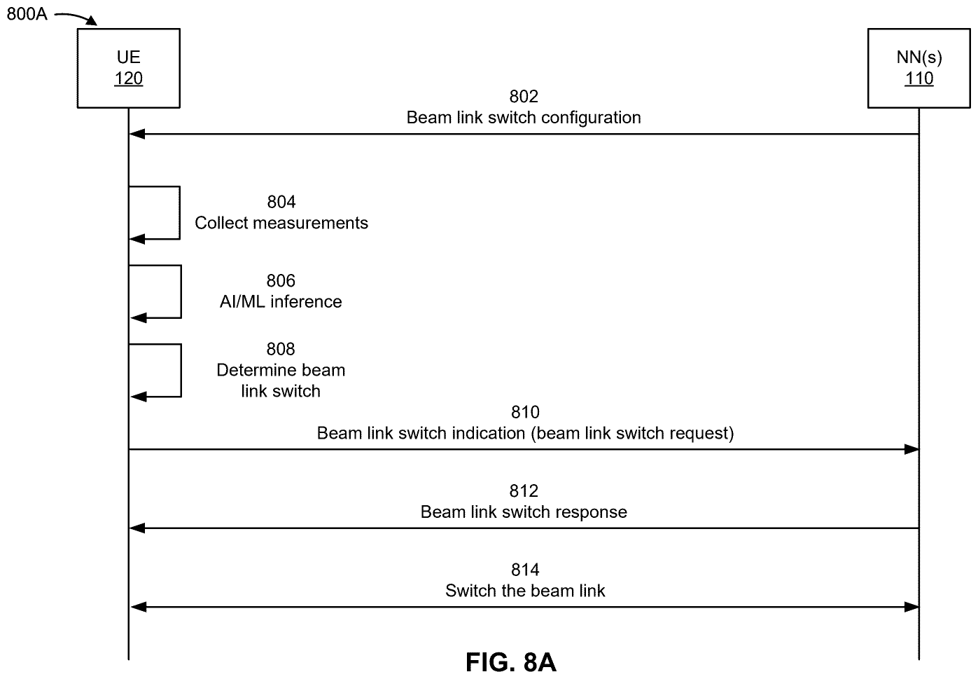

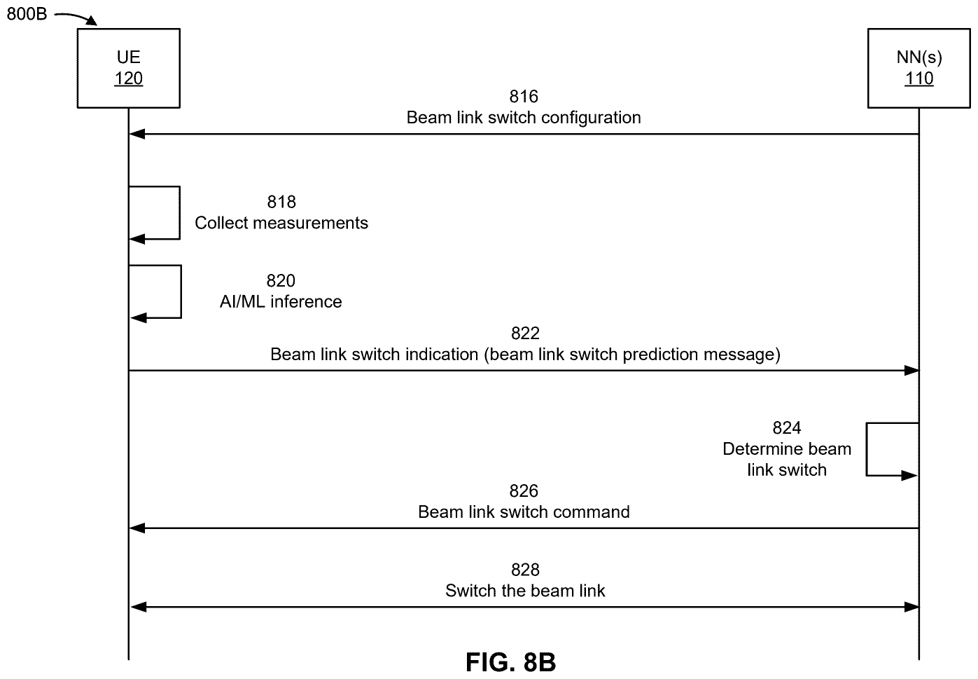

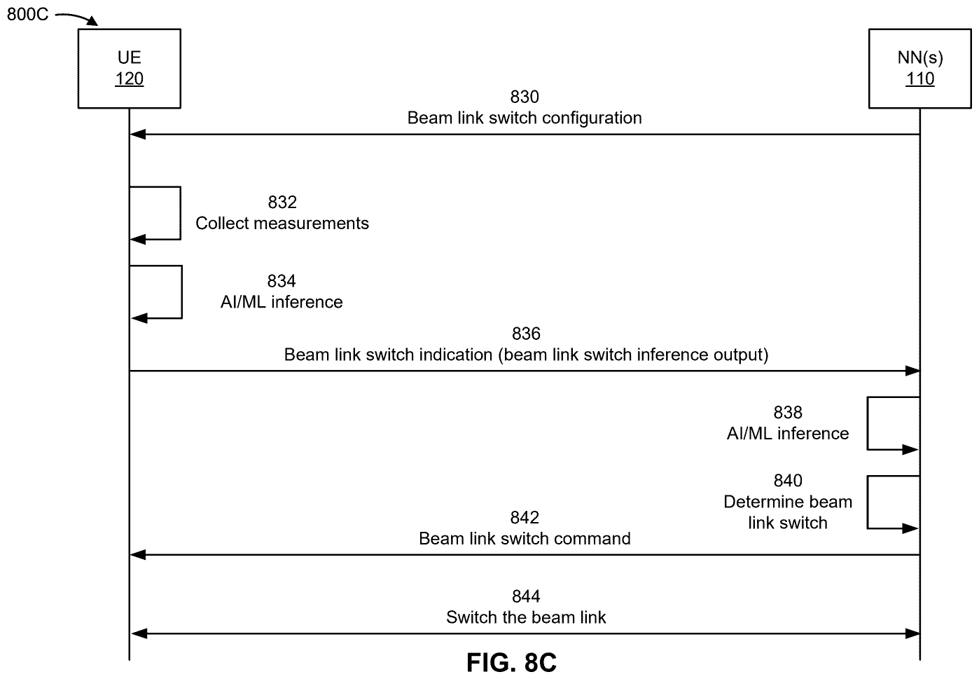

As shown by reference number 520, the UE 120 may transmit, and the network node 110 may receive, based at least in part on the one or more beam link switch types, a beam link switch indication. For example, the UE 120 may transmit the beam link switch indication responsive to the AI/ML inference or prediction on beam link switch. The beam link switch indication may indicate that the UE 120 is to perform one or more beam link switches of one or more beam link switch types. As discussed in greater detail below in connection with FIGS. 8A-8C, the beam link switch indication may comprise a beam link switch request, a beam link switch prediction message, a beam link switch inference, or the like.

As indicated above, FIG. 5 is provided as an example. Other examples may differ from what is described with respect to FIG. 5.

FIG. 6 is a diagram illustrating an example 600 associated with AI/ML inference or prediction, in accordance with the present disclosure.

In some cases (e.g., 6G), AI/ML features may empower the UE 120 to enable smart UE implementations, such as making effective decisions or predictions to assist the network node 110 in managing beam links efficiently. For example, the UE 120 may collect large amounts of data, which may be provided as one or more inputs to the AI/ML model. In examples involving AI/ML, the beam link switch configuration may comprise an AI/ML configuration for beam link switch prediction.

Example 600 shows an AI/ML model 605 that can receive various inputs. In some examples, the inputs may comprise the one or more beam link switch parameters discussed above in connection with FIG. 5. In some examples, the one or more inputs may include beam measurements 610 (e.g., L1 and/or L2 measurements associated with a selected SSB, tracking reference signal (TRS), CSI-RS, or the like). The beam measurements 610 may include one or more of a serving beam measurement 615, one or more serving cell candidate beam measurements 620 (e.g., L1 and/or L2 measurements associated with one or more selected SSBs, TRSs or CSI-RSs), or one or more neighboring or candidate cell beam measurements 625 (e.g., L1 and/or L2 measurements associated with one or more monitored SSBs, TRSs, or CSI-RSs).

In some examples, the one or more inputs may include UE information 630. The UE information 630 may include one or more of a UE position 635 (e.g., a UE location within a cell, such as whether or not the UE 120 is at a cell center or cell edge), a UE velocity 640 (e.g., a speed and/or direction of the UE 120 moving away or toward the cell edge), a UE orientation 645 (e.g., a UE rotation), or the like.

In some examples, the one or more inputs may include channel information 650. The channel information 650 may include a channel propagation 685 (e.g., a channel propagation type, such as line-of-sight or non-line-of-sight), a channel response 690 (e.g., a time domain response or an angular domain response), a channel environment 695 (e.g., surrounding physical structures such as high buildings, trees or the like), or the like.

In some examples, the one or more inputs may include AI/ML parameters 655. The AI/ML parameters 655 may include one or more of one or more intra-group beam switching parameters 660 (e.g., a timer with a range of values for L1 beam measurement (e.g., based at least in part on UE information 630 or channel information 650), a threshold with a range of values for triggering an intra-group beam switching (e.g., based at least in part on UE information 630, channel information 650, or beam measurements 610), a time window or timeline with a range of values for intra-group beam switching (e.g., based at least in part on UE information 630 or channel information 650), or the like), one or more inter-group beam switching parameters 665 (e.g., a timer with a range of values for L1 beam measurement (e.g., based at least in part on UE information 630 or channel information 650), a threshold with a range of values for triggering a serving beam failure (e.g., based at least in part on UE information 630, channel information 650, or beam measurements 610), a counter with a range of values for counting serving beam failures and triggering an inter-group beam switching (e.g., based at least in part on UE information 630, channel information 650, or beam measurements 610), a time window or a timeline with a range of values for inter-group beam switching (e.g., based at least in part on UE information 630 or channel information 650), or the like), or one or more inter-cell beam switching parameters 675 (e.g., a timer with a range of values for L1 beam measurement (e.g., based at least in part on UE information 630 or channel information 650), a threshold with a range of values for triggering an inter-cell beam switching (e.g., based at least in part on UE information 630, channel information 650, or beam measurements 610), a time window or a timeline with a range of values for inter-group beam switching (e.g., based at least in part on UE information 630 or channel information 650), or the like).

In some aspects, the beam link switch indication (discussed above in connection with reference number 520 (FIG. 5)) may be based at least in part on an AI/ML inference or prediction (e.g., an AI/ML inference). For example, the AI/ML model 605 may output, based at least in part on the input(s), an AI/ML inference or prediction 680. The AI/ML inference or prediction 680 may comprise an AI/ML beam link inference or prediction, a beam link change inference or prediction (e.g., an AI/ML-based beam link change inference or prediction), or the like. The AI/ML inference or prediction 680 may produce features for further beam link change inference or predict a need for an intra-group beam switch, an inter-group beam switch, an inter-cell beam switch, or the like. In some examples, the beam link switch configuration (discussed above in connection with reference number 510 (FIG. 5)) may comprise an AI/ML configuration for the AI/ML inference or prediction 680. For example, the beam link switch configuration may configure the AI/ML parameters 655 for a beam link change. Thus, the AI/ML model 605 may enable AI/ML-based beam link management, such as a unified AI/ML-based beam link management procedure.

As indicated above, FIG. 6 is provided as an example. Other examples may differ from what is described with respect to FIG. 6.

FIG. 7 is a diagram illustrating an example 700 associated with beam link switch parameter configuration, in accordance with the present disclosure. As shown in FIG. 7, a network node 110 and a UE 120 may communicate with one another.

Example 700 shows a series of candidate beams that can be switched in accordance with implementations described herein. A first set of beams 710 (e.g., a first set of SSB beams), a first group of beams 720 (e.g., a first group of CSI-RS beams), a second set of beams 730 (e.g., a second set of SSB beams), and a second group of beams 740 (e.g., a second group of CSI-RS beams) are associated with (e.g., can be used for communication with) a serving cell 750. In some examples, the selected SSB beam 715 or the selected SSB beam 735 can be used for initial communication(s) (e.g., via a RACH-based procedure) with the serving cell 750. In some examples, the serving beam 725 of the first group of beams 720 (associated with the selected SSB beam 715), or the serving beam 745 of the second group of beams 740 (associated with the selected SSB beam 735) can be used for communication(s) (e.g., downlink or uplink control or data communications) with the serving cell 750. A third set of beams 760 (e.g., a third set of SSB beams) may be associated with (e.g., can be used for monitoring, measurement of, or initial communication with) a first candidate cell 770, and a fourth set of beams 780 (e.g., a fourth set of SSB beams) may be associated with (e.g., can be used for monitoring, measurement of, or initial communication with) a second candidate cell 790.

In some aspects, a beam link switch type of the plurality of beam link switch types is associated with intra-group beam switching associated with a selected SSB. Intra-group beam switching may refer to beam switching within a group of beams. The intra-group beam switching may be associated with the selected SSB in that each beam in the group of beams corresponds to the selected SSB. For example, the first set of beams 710 may carry respective SSBs (e.g., SSB beams), one of which may be selected. The first group of beams 720 may correspond to the selected SSB (e.g., the selected SSB beam 715) and may carry respective CSI-RSs (e.g., CSI-RS beams). For example, the first set of beams 710 may be wide beams, and the first group of beams 720 may be narrow beams. In some examples, the first group of beams 720 may include a current serving beam. One of the CSI-RSs may be selected, and the beam corresponding to the selected CSI-RS may become a new serving beam. Thus, the serving beam may switch from a first beam (e.g., the serving beam 725) in the first group of beams 720 to a second beam (e.g., the serving beam 727) in the first group of beams 720. In some examples, intra-group beam switching may comprise beam switching as described above in connection with FIG. 4A.

In some aspects, a beam link switch type of the plurality of beam link switch types is associated with inter-group beam switching associated with multiple selected SSBs. Inter-group beam switching may refer to beam switching between different sets of beams. The inter-group beam switching may be associated with multiple selected SSBs in that the set of beams involved in the switching correspond to respective selected SSBs. For example, the second set of beams 730 may carry respective SSBs, one of which may be selected. The SSB selected from the second set of beams 730 may be different than the SSB selected from the first set of beams 710. The second group of beams 740 may correspond to the selected SSB and may carry respective CSI-RSs. For example, the second set of beams 730 may be wide beams, and the second group of beams 740 may be narrow beams. One of the CSI-RSs may be selected, and the beam corresponding to the selected CSI-RS may become a new serving beam. Thus, the serving beam may switch from a beam (e.g., the serving beam 725) in the first group of beams 720, corresponding to the SSB selected from the first set of beams 710 (e.g., the selected SSB beam 715), to a beam (e.g., the serving beam 745) in the second group of beams 740, corresponding to the SSB selected from the second set of beams 730 (e.g., the selected SSB beam 735). In some examples, inter-group beam switching may comprise beam failure detection and recovery as described above in connection with FIG. 4B.

In some aspects, a beam link switch type of the plurality of beam link switch types is associated with inter-cell beam switching. Inter-cell beam switching may refer to beam switching between different cells. For example, the third set of beams 760, corresponding to the first candidate cell 770, and the fourth set of beams 780, corresponding to the second candidate cell 790, may carry respective SSBs, one of which may be selected. Thus, the serving beam may switch from a beam (e.g., the serving beam 725 or the serving beam 745) in the serving cell 750 to a beam in the first candidate cell 770 (e.g., the selected SSB beam 765) or the second candidate cell 790 (e.g., the selected SSB beam 785). In some examples, inter-cell beam switching may comprise LTM as described above in connection with FIG. 4C.

In some aspects, the beam link switch configuration may comprise a hierarchical structure. In some examples, a first level of the hierarchy may comprise a cell list; a second level of the hierarchy (e.g., under the first level) may comprise a per-cell L1 or L2 beam measurement (e.g., using an SSB beam); a third level of the hierarchy (e.g., under the second level) may comprise a per-selected-SSB L1 or L2 candidate beam measurement (e.g., using a CSI-RS beam associated with a SSB); and a fourth level of the hierarchy (e.g., under the third level) may comprise a per-CSI-resource-indication or per-TCI-state L1 or L2 serving beam measurement. In some examples, a first level of the hierarchy may comprise a candidate cell list; a second level of the hierarchy may comprise per-cell thresholds (e.g., minimum thresholds, maximum thresholds, one or more ranges of thresholds, or the like) for inter-cell beam link change inference or prediction (e.g., inference or prediction for beam link switch, such as LTM as described in FIG. 4C); a third level of the hierarchy may comprise per-SSB thresholds (e.g., minimum thresholds, maximum thresholds, one or more ranges of thresholds, or the like) for inter-group (or inter-SSB) beam link change inference or prediction (e.g., inference or prediction for beam link switch, such as beam failure recovery as described in FIG. 4B); and a fourth level of the hierarchy may comprise per-serving-beam or per-candidate-beam thresholds (e.g., minimum thresholds, maximum thresholds, one or more ranges of thresholds, or the like) for intra-group beam link change inference or prediction (e.g., prediction for beam link switch, such as beam switch as described in FIG. 4A). Additionally, or alternatively, the second level of the hierarchy may comprise per-cell timers and/or counters (e.g., minimum values, maximum values, one or more ranges of values, or the like) for beam link change inference or prediction (e.g., inference or prediction for beam link switch, such as LTM); the third level of the hierarchy may comprise per-SSB timers and/or counters (e.g., minimum values, maximum values, one or more ranges of values, or the like) for beam link change inference or prediction (e.g., inference or prediction for beam link switch, such as beam failure recovery); and a fourth level of the hierarchy may comprise per-serving-beam or per-candidate-beam timers and/or counters (e.g., minimum values, maximum values, one or more ranges of values, or the like) for beam link change inference or prediction (e.g., inference or prediction for beam link switch, such as beam switching).

As indicated above, FIG. 7 is provided as an example. Other examples may differ from what is described with respect to FIG. 7.

FIGS. 8A-8C are diagrams illustrating examples 800A-800C associated with respective approaches for a unified framework for beam link management, in accordance with the present disclosure. As shown in FIGS. 8A-8C, a network node 110 and a UE 120 may communicate with one another.

With reference to FIG. 8A, example 800A illustrates a first approach for a unified framework for beam link management.

As shown by reference number 802, the network node 110 may transmit, and the UE 120 may receive, a beam link switch configuration. The beam link switch configuration may indicate one or more beam link switch parameters, as discussed above in connection with reference number 510 (FIG. 5). As shown by reference number 804, the UE 120 may collect beam measurements (e.g., L1 or L2 beam measurements, as discussed above in connection with reference number 610 (FIG. 6)) and/or other measurements (e.g., for UE information or channel information, as discussed above in connection with reference number 630 or reference number 650, respectively (FIG. 6)) based at least in part on the beam link switch configuration. As shown by reference number 806, the UE 120 may perform AI/ML inference to generate a beam link change prediction. As shown by reference number 808, the UE 120 may determine, based at least in part on the beam link change prediction, that the beam link switch is to occur.

As shown by reference number 810, the UE 120 may transmit, and the network node 110 may receive, responsive to the determination that the beam link switch is to occur, a beam link switch indication (e.g., as discussed above in connection with reference number 520 (FIG. 5)). In some aspects, the beam link switch indication may comprise a beam link switch request. The beam link switch request may comprise a message that requests the network node 110 to permit a beam link switch.

In some aspects, the beam link switch request may indicate one or more of one or more causes associated with the beam link switch request, one or more target beams, or one or more time windows. The one or more causes may be associated with the beam link switch request in that the one or more causes may comprise one or more reasons why the UE 120 transmitted the beam link switch request. For example, the one or more causes may include one or more codes corresponding to intra-group beam link switch, inter-group beam switch, or inter-cell beam link switch. In some examples, the beam link switch request may include (e.g., explicitly indicate) one or more priorities or weights corresponding to one or more beam link switching types. In some examples, an intra-group beam link switch request may have a higher priority or weight than that of an inter-group beam link switch request, based at least in part on UE information (e.g., low mobility and/or at a cell center) or channel information (e.g., stable channel measurement and/or prediction). In some examples, an inter-cell beam link switch request may have a higher priority or weight than that of an inter-group beam link switch request, based at least in part on UE information (e.g., the UE moving with high mobility toward the cell edge) or channel information (e.g., degraded channel measurement and/or prediction).

The one or more target beams may comprise one or more candidate beams to which the UE 120 can switch. For example, the beam link switch request may indicate one or more beam indexes corresponding to the one or more target beams, one or more SSB indexes or CSI-RS resource indicators corresponding to the one or more target beams, one or more transmission configuration indicators (TCIs) corresponding to the one or more target beams, or the like. Additionally, or alternatively, one or more cell identifiers corresponding to the respective beams of one or more cells, one or more TRP identifiers or indexes corresponding to respective beams of the one or more TRPs, or one or more DU identifiers or indexes corresponding to the respective beams of the one or more DUs may be indicated for inter-cell beam link switch, inter-TRP beam link switch, or inter-DU beam link switch, respectively.

The one or more time windows may indicate one or more timelines for the beam link switch procedure (e.g., the time window(s) may comprise one or more timers or counters for one or more beam link switching types (e.g., intra-group beam link switch, inter-group beam switch, or inter-cell beam link switch), or one or more timers or counters for one or more quality of service (QoS) requirements of certain communications (e.g., multi-model communications with different reliabilities or latencies).

In some aspects, the beam link switch request may comprise one or more of a MAC-CE or a RACH message. For example, the MAC-CE or the RACH message may be containers for the beam link switch request. The MAC-CE may be a MAC-CE transmitted on the serving beam (e.g., the current beam before the beam link switch). The UE 120 may transmit the MAC-CE using any available grant for PUSCH satisfying a time requirement (e.g., with an offset (e.g., configured in the beam link switch configuration) before or at a start of a timeline or time window for a beam link switch) corresponding to the timeline of an indicated cause (e.g., a beam link switch type), or, if no such grants are available, the UE 120 may request a grant for PUSCH (e.g., meeting the time requirement corresponding to the timeline of an indicated cause or beam link switch type). The RACH message may be a RACH message 1 or a RACH message 3transmitted on a beam associated with a best selected SSB. The RACH (e.g., sequence, time resource, frequency resource, or the like) may involve contention-free random access (CFRA) (e.g., using a RACH message 1, where the RACH is dedicated for beam link switch requests) or contention-based random access (CBRA) (e.g., using a RACH message 3, where the RACH for beam link switch requests is shared with other RACH operations). In some aspects, a MAC-CE may be used based at least in part on the prediction of a beam link change (e.g., the timeline predicted for the beam link change), the channel condition or status (e.g., based at least in part on RSRP, RSRQ or signal-to-interference-plus-noise ratio (SINR) measurement or prediction of the serving beam, which may be above a first threshold (e.g., configured in the beam link switch configuration) for reliable PUSCH transmission), or the available grant of PUSCH satisfying the timeline requirement. In some aspects, RACH may be used based at least in part on the prediction of a beam link change (e.g., the timeline predicted for the change), the channel condition or status (e.g., based at least in part on RSRP, RSRQ or SINR measurement or prediction of the serving beam, which may be below a second threshold (e.g., configured in the beam link switch configuration) for reliable PUSCH transmission), or no available grant of PUSCH satisfying the time requirement.

As shown by reference number 812, the network node 110 may transmit, and the UE 120 may receive, a beam link switch response. The beam link switch response may be based at least in part on the beam link switch request. For example, the beam link switch response may indicate that the UE 120 is permitted to perform the beam link switch requested in the beam link switch request. As shown by reference number 814, the network node 110 and the UE 120 may perform the beam link switch.

In some aspects, the network node 110 may indicate one or more selected beams (e.g., beam indexes or identifier, cell identifier, TRP indexes or identifier, or DU indexes or identifier, as described above) from the one or more beams indicated in the beam link switch request or one or more that are beams different from the one or more beams indicated in the beam link switch request (e.g., based at least in part on network load balancing or scheduling, the network interference control, the monitoring of AI/ML model performance, or the like).

In some aspects, the network node 110 may indicate a cause (e.g., a beam link switch type) selected from the one or more causes (e.g., beam switch types) indicated in the beam link switch request or a cause different from the one or more causes indicated in the beam link switch request (e.g., based at least in part on the network load balancing or scheduling, the network interference control, the monitoring of AI/ML model performance, or the like).

Additionally, or alternatively, the network node 110 may transmit an additional CSI-RS with or after the beam link switch response for fine-tuning the new serving beam for intra-group beam link switch or for selecting a new serving beam from the new group of beams (e.g., a new group of candidate beams associated with a newly selected SSB) for inter-group beam link switch.

With reference to FIG. 8B, example 800B illustrates a second approach for a unified framework for beam link management.

As shown by reference number 816, the network node 110 may transmit, and the UE 120 may receive, a beam link switch configuration. The beam link switch configuration may indicate one or more beam link switch measurement parameters, as discussed above in connection with reference number 510 (FIG. 5). As shown by reference number 818, the UE 120 may collect beam measurements (e.g., L1 or L2 beam measurements) and/or other measurements (e.g., for UE information or channel information) based at least in part on the beam link switch configuration. As shown by reference number 820, the UE 120 may perform AI/ML inference to generate a beam link change prediction.

As shown by reference number 822, the UE 120 may transmit, and the network node 110 may receive, based at least in part on the beam link change prediction, a beam link switch indication (e.g., as discussed above in connection with reference number 520 (FIG. 5)). In some aspects, the beam link switch indication may comprise a beam link switch prediction message. The beam link switch prediction message may assist the network node 110 in determining whether a beam link switch is to occur.

In some aspects, the beam link switch prediction message may indicate one or more of one or more beam link switch predictions, one or more target beams, or one or more time points. The one or more beam link switch predictions may comprise one or more predictions that one or more beam switches are to occur (e.g., intra-group beam link switching, inter-group beam link switching, and/or inter-cell beam link switching). In some examples, the beam link switch prediction message may include a prediction accuracy and/or probability corresponding to the one or more beam link switch predictions. In some examples, the beam link switch prediction message may include (e.g., explicitly indicate) the one or more priorities or weights corresponding one or more beam link switching types. In some examples, a priority or weight for intra-group beam link switch prediction may be higher than that for inter-group beam link switch prediction, based at least in part on the UE information (e.g., low mobility and at a cell center) or the channel information (e.g., stable channel measurement or prediction). In some examples, a priority or weight for inter-cell beam link switch prediction may be higher than that for inter-group beam link switch prediction, based at least in part on the UE information (e.g., high mobility toward a cell edge) or the channel information (e.g., degraded channel measurement or prediction).

The one or more target beams may comprise one or more candidate beams to which the UE 120 can switch. For example, the beam link switch prediction message may include one or more beam indications for the one or more candidate beams according to (e.g., in order of) one or more priorities or weights associated with the one or more candidate beams (e.g., using one or more beam indexes corresponding to the one or more target beams, one or more SSB indexes or CSI-RS resource indicators corresponding to the one or more target beams, one or more TCIs corresponding to the one or more target beams, or the like). Additionally, or alternatively, one or more cell identifiers corresponding to the respective beams of one or more cells, one or more TRP identifiers or indexes corresponding to the respective beams of the one or more TRPs, or one or more DU identifiers or indexes corresponding to the respective beams of DUs may be indicated for inter-cell beam link switch, inter-TRP beam link switch or inter-DU beam link switch, respectively.

The one or more time points may be associated with the one or more beam link switch predictions. For example, the one or more time points may indicate that an intra-group beam link switch will occur at time t1, an inter-group beam link switch will occur at time t2, and/or an inter-cell beam link switch will occur at time t3.

In some aspects, the beam link switch prediction message may comprise one or more of a MAC-CE or a RACH message. For example, the MAC-CE or the RACH message may be containers for the beam link switch prediction message. The MAC-CE may be a MAC-CE transmitted on the serving beam. The UE 120 may transmit the MAC-CE using any available grant for PUSCH satisfying the time requirement for the time point indicated in the beam link switch prediction (e.g., with an offset (e.g., configured in the beam link switch configuration) before the time point indicated in the beam link switch prediction), or, if no such grants are available, the UE 120 may request a grant for PUSCH satisfying the time requirement for the time point indicated in the beam link switch prediction. The RACH message may be a RACH message 1 or a RACH message 3 transmitted on a beam associated with a best selected SSB. The RACH may involve CFRA (e.g., using RACH message 1 where the RACH is dedicated for beam link switch requests) or CBRA (e.g., using RACH message 3 where the RACH for beam link switch requests is shared with other RACH operations). In some aspects, a MAC-CE may be used based at least in part on the prediction of a beam link change (e.g., the time point predicted for the beam link change) or the channel condition or status (e.g., based on RSRP, RSRQ or SINR measurement or prediction of the serving beam, which may be above a first threshold (e.g., configured in the beam link switch configuration) for reliable PUSCH transmission) or the available grant of PUSCH meeting the timeline requirement. In some aspects, RACH may be used based at least in part on the prediction of a beam link change (e.g., the time point predicted for the beam link change) or the channel condition or status (e.g., based at least in part on RSRP, RSRQ or SINR measurement or prediction of the serving beam, which may be below a second threshold (e.g., configured in the beam link switch configuration) for reliable PUSCH transmission) or no available grant of PUSCH satisfying the time requirement.

As shown by reference number 824, the network node 110 may determine, based at least in part on the beam link switch prediction message, that the beam link switch is to occur. As shown by reference number 826, the network node 110 may transmit, and the UE 120 may receive, a beam link switch command with a cause indicated (e.g., an intra-group beam link switch, an inter-group beam link switch or an inter-cell beam link switch). Additionally, or alternatively, the network node 110 may include the timeline corresponding the cause indicated (e.g., a timeline for the respective intra-group beam link switch, inter-group beam link switch or inter-cell beam link switch based at least in part on the one or more time points indicated in the beam link switch prediction). The beam link switch command may be based at least in part on the beam link switch prediction message. For example, the beam link switch command may indicate that the UE 120 is to perform the beam link switch. As shown by reference number 828, the network node 110 and the UE 120 may perform the beam link switch.

In some aspects, the network node 110 may indicate one or more selected beams (e.g., beam indexes or identifiers, cell identifiers, TRP indexes or identifiers, or DU indexes or identifiers, as described above) from the one or more beams indicated in the beam link switch prediction or one or more beams different from the one or more beams indicated in the beam link switch prediction (e.g., based at least in part on the network load balancing or scheduling, network interference control, monitoring of AI/ML model performance, or the like).

In some aspects, the network node 110 may indicate a cause (e.g., beam link switch type) selected from the one or more causes (e.g., beam switch types) indicated in the beam link switch prediction or a cause different from the one or more causes indicated in the beam link switch prediction (e.g., based at least in part on the network load balancing or scheduling, network interference control, monitoring of AI/ML model performance, or the like).

Additionally, or alternatively, the network node 110 may transmit an additional CSI-RS with or after the beam link switch command for fine-tuning the new serving beam for intra-group beam link switch, or for selecting a new serving beam from the new group of beams (e.g., a new group of candidate beams associated with a newly selected SSB) for inter-group beam link switch.

With reference to FIG. 8C, example 800C illustrates a third approach for a unified framework for beam link management.

As shown by reference number 830, the network node 110 may transmit, and the UE 120 may receive, a beam link switch configuration. The beam link switch configuration may indicate one or more beam link switch measurement parameters, as discussed above in connection with reference number 510 (FIG. 5). As shown by reference number 832, the UE 120 may collect beam measurements (e.g., L1 or L2 beam measurements) and/or other measurements (e.g., for UE information or channel information) based at least in part on the beam link switch configuration. As shown by reference number 834, the UE 120 may perform AI/ML inference to generate a first stage beam link change inference output. The UE 120 performing the AI/ML inference may be referred to as a first stage of AI/ML inference (e.g., split AI/ML inference for beam link switch prediction between the UE 120 and the network node 110). In some aspects, the first stage of AI/ML inference may be used for pre-processing or compressing the input data for inference at the network node 110, which may reduce the signaling or message overhead compared to the overhead associated with L1 or L2 beam measurement reports and other measurement reports that would otherwise be used for the inference at the network node 110.

As shown by reference number 836, the UE 120 may transmit, and the network node 110 may receive, based at least in part on the first stage of AI/ML inference, a beam link switch indication (e.g., as discussed above in connection with reference number 520 (FIG. 5)). In some aspects, the beam link switch indication may comprise a beam link switch inference (e.g., a beam link switch inference output, such as a first-stage beam link switch inference output). The beam link switch inference may comprise a compressed data report that assists the network node 110 in performing a second state of AI/ML inference for the beam link change prediction.

In some aspects, the beam link switch inference (e.g., the beam link switch inference output) may indicate (e.g., include) one or more of one or more beam link switch inference features, tokens, or vectors, one or more ingredients or weights, one or more metadata or labels associated with the beam link switch inference (e.g., associated with the features or tokens or vectors for a second-stage AI/ML beam link switch inference, the ingredients or weights for second-stage AI/ML online or real-time training or monitoring), or one or more time stamps associated with the beam link switch inference (e.g., associated with one or more beam link switch inference outputs from the first stage AI/ML inference). The one or more beam link switch inference features or tokens or vectors may comprise one or more beam link switch inference features or tokens or vectors that are outputted by or extracted from the first stage of AI/ML inference (e.g., measurable characteristics or attributes of the data as the inputs to make predictions at the second-stage beam link switch inference). The one or more ingredients or weights may correspond to the beam link switch AI/ML model online or real-time training or monitoring and may be outputted by or extracted from a first stage of AI/ML model online or real time training or monitoring. The metadata or labels may be associated with the beam link switch inference in that the metadata or labels may correspond to the one or more beam link switch inference features, tokens or vectors to the second stage beam link switch inference (e.g., to assist the desired outcomes or predictions at the second stage of beam link switch inference). The metadata or labels may be associated with the beam link switch AI/ML model training in that the metadata or labels may correspond to the one or more ingredients or weights (e.g., to assist the online or real time training or monitoring). The one or more time stamps may be associated with the beam link switch inference (e.g., the beam link switch inference output) in that the one or more time stamps may correspond to the one or more beam link switch inference features or tokens or vectors for the second-stage AI/ML inference and/or the one or more ingredients or weights for the second-stage AI/ML model online or real time training or monitoring.

In some aspects, the beam link switch inference may comprise one or more of a control message (e.g., an RRC message on a PUSCH) or a data message (e.g., an AI/ML data payload on a PUSCH). For example, the control message or the data message may be containers for the beam link switch inference. In some examples, the control message may be carried in the control plane. In some examples, the data message may be carried in the user plane. The UE 120 may transmit the control message or the data message on the serving beam using any available grant for PUSCH (e.g., satisfying the timing requirement for feeding the second stage beam link switch AI/ML inference), or, if no such grants are available, the UE 120 may request a grant for PUSCH (e.g., with the timing requirement for feeding the second stage beam link switch AI/ML inference).

As shown by reference number 838, the network node 110 may perform, based at least in part on the beam link switch inference output, AI/ML inference to generate a beam link change prediction. The network node 110 performing the AI/ML inference may be referred to as a second stage of AI/ML inference. As shown by reference number 840, the network node 110 may determine, based at least in part on the second stage of the AI/ML inference, that the beam link switch is to occur. As shown by reference number 842, the network node 110 may transmit, and the UE 120 may receive, a beam link switch command. The beam link switch command may be based at least in part on the beam link switch prediction message. For example, the beam link switch command (e.g., as described above in connection with reference number 826 in FIG. 8B) may indicate that the UE 120 is to perform the beam link switch. As shown by reference number 844, the network node 110 and the UE 120 may perform the beam link switch.

As indicated above, FIGS. 8A-8C are provided as examples. Other examples may differ from what is described with respect to FIGS. 8A-8C.

The beam link switch configuration indicating one or more beam link switch parameters that are associated with a plurality of beam link switch types may help to conserve memory resources, processing resources, or the like. For example, the beam link switch configuration may enable the UE 120 to refrain from performing redundant L1 measurements for respective beam link switch types. Thus, the beam link switch configuration may improve efficiency of intra-cell and/or inter-cell beam link management (e.g., for 6G use cases).

The beam link switch indication being based at least in part on an AI/ML inference or prediction may enable use of UE AI/ML capability support to render holistic beam link management decisions regarding a beam link switch before the current beam link is no longer usable. For example, the UE 120 and/or the network node 110 may determine whether or not to perform the beam link switch may be based at least in part on the AI/ML prediction (e.g., a beam link change prediction). In some examples, the AI/ML prediction may perform an optimization based at least in part on a trade-off between intra-group beam switching and inter-group beam switching, a trade-off between inter-group beam switching and inter-cell beam switching, or the like. In some examples, the AI/ML prediction may help to determine whether to perform intra-cell beam link switching (e.g., intra-group or inter-group beam switching, or the like) and/or inter-cell beam link switching (e.g., beam handover, LTM, or the like).

The beam link switch indication comprising a beam link switch request may help to reduce overhead by enabling the UE 120 to make a beam link switching decision, and, thus, avoid transmitting beam measurement and/or other measurement reports.

The beam link switch indication comprising a beam link switch prediction message may help to improve decision-making with reduced overhead by enabling the network node 110 to make a beam link switching decision and enabling the UE 120 to transmit compressed beam measurement and/or other measurement reports based at least in part on a beam link switch prediction at the UE-side.

The beam link switch indication comprising a beam link switch inference may enable beam link switch prediction functionality to be split between the UE 120 and the network node 110, thereby enabling the network node 110 to make a beam link switching decision based at least in part on AI/ML beam link switch inference at the network-side and enabling the UE 120 to transmit compressed beam measurement and/or other measurement reports.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with a beam link switch configuration for multiple beam link switch types.

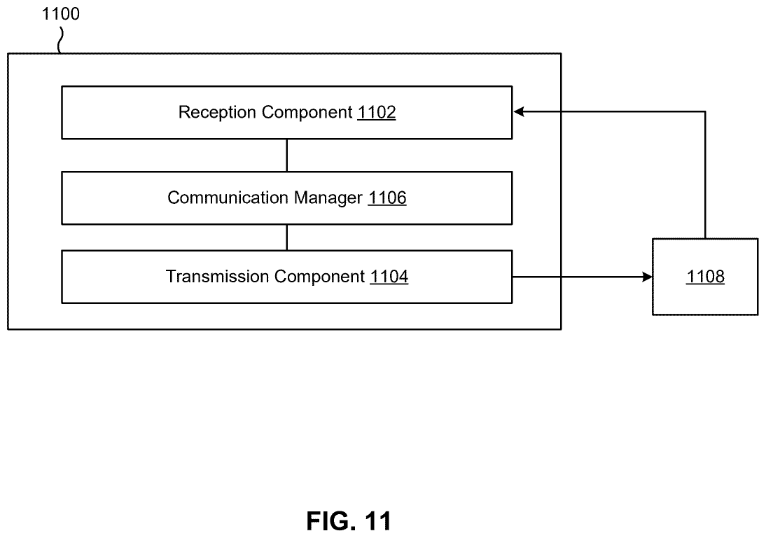

As shown in FIG. 9, in some aspects, process 900 may include receiving a beam link switch configuration that indicates one or more beam link switch parameters associated with a plurality of beam link switch types (block 910). For example, the UE (e.g., using reception component 1102 and/or communication manager 1106, depicted in FIG. 11) may receive a beam link switch configuration that indicates one or more beam link switch parameters associated with a plurality of beam link switch types, as described above in connection with FIGS. 5-8C.

As further shown in FIG. 9, in some aspects, process 900 may include transmitting, based at least in part on one or more beam link switch types of the plurality of beam link switch types, a beam link switch indication (block 920). For example, the UE (e.g., using transmission component 1104 and/or communication manager 1106, depicted in FIG. 11) may transmit, based at least in part on one or more beam link switch types of the plurality of beam link switch types, a beam link switch indication, as described above in connection with FIGS. 5-8C.

Process 900 may include additional aspects, such as any single aspect or any combination of aspects described below and/or in connection with one or more other processes described elsewhere herein.

In a first aspect, the beam link switch indication is based at least in part on an AI/ML inference or prediction.

In a second aspect, alone or in combination with the first aspect, a beam link switch type of the plurality of beam link switch types is associated with intra-group beam switching associated with a selected SSB.

In a third aspect, alone or in combination with one or more of the first and second aspects, a beam link switch type of the plurality of beam link switch types is associated with inter-group beam switching associated with multiple selected SSBs.

In a fourth aspect, alone or in combination with one or more of the first through third aspects, a beam link switch type of the plurality of beam link switch types is associated with inter-cell beam switching.

In a fifth aspect, alone or in combination with one or more of the first through fourth aspects, the beam link switch configuration comprises a hierarchical structure.

In a sixth aspect, alone or in combination with one or more of the first through fifth aspects, the beam link switch indication comprises a beam link switch request.

In a seventh aspect, alone or in combination with one or more of the first through sixth aspects, the beam link switch request indicates one or more of one or more causes associated with the beam link switch request, one or more target beams, or one or more time windows.

In an eighth aspect, alone or in combination with one or more of the first through seventh aspects, the beam link switch request comprises one or more of a MAC-CE or a RACH message.

In a ninth aspect, alone or in combination with one or more of the first through eighth aspects, the beam link switch indication comprises a beam link switch prediction message.

In a tenth aspect, alone or in combination with one or more of the first through ninth aspects, the beam link switch prediction message indicates one or more of one or more beam link switch predictions, one or more target beams, or one or more time points.

In an eleventh aspect, alone or in combination with one or more of the first through tenth aspects, the beam link switch prediction message comprises one or more of a MAC-CE or a RACH message.

In a twelfth aspect, alone or in combination with one or more of the first through eleventh aspects, the beam link switch indication comprises a beam link switch inference.

In a thirteenth aspect, alone or in combination with one or more of the first through twelfth aspects, the beam link switch inference indicates one or more of one or more beam link switch inference features, one or more ingredients or weights, metadata associated with the beam link switch inference, or one or more time stamps associated with the beam link switch inference.

In a fourteenth aspect, alone or in combination with one or more of the first through thirteenth aspects, the beam link switch inference comprises one or more of a control message or a data message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with a beam link switch configuration for multiple beam link switch types.

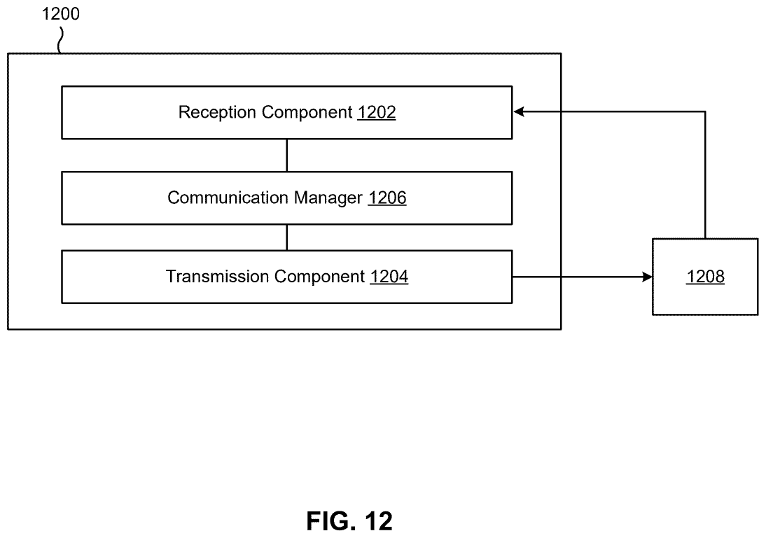

As shown in FIG. 10, in some aspects, process 1000 may include transmitting a beam link switch configuration that indicates one or more beam link switch parameters associated with a plurality of beam link switch types (block 1010). For example, the network node (e.g., using transmission component 1204 and/or communication manager 1206, depicted in FIG. 12) may transmit a beam link switch configuration that indicates one or more beam link switch parameters associated with a plurality of beam link switch types, as described above in connection with FIGS. 5-8C.

As further shown in FIG. 10, in some aspects, process 1000 may include receiving, based at least in part on one or more beam link switch types of the plurality of beam link switch types, a beam link switch indication (block 1020). For example, the network node (e.g., using reception component 1202 and/or communication manager 1206, depicted in FIG. 12) may receive, based at least in part on one or more beam link switch types of the plurality of beam link switch types, a beam link switch indication, as described above in connection with FIGS. 5-8C.

Process 1000 may include additional aspects, such as any single aspect or any combination of aspects described below and/or in connection with one or more other processes described elsewhere herein.

In a first aspect, the beam link switch indication is based at least in part on an AI/ML inference or prediction.

In a second aspect, alone or in combination with the first aspect, a beam link switch type of the plurality of beam link switch types is associated with intra-group beam switching associated with a selected SSB.

In a third aspect, alone or in combination with one or more of the first and second aspects, a beam link switch type of the plurality of beam link switch types is associated with inter-group beam switching associated with multiple selected SSBs.

In a fourth aspect, alone or in combination with one or more of the first through third aspects, a beam link switch type of the plurality of beam link switch types is associated with inter-cell beam switching.

In a fifth aspect, alone or in combination with one or more of the first through fourth aspects, the beam link switch configuration comprises a hierarchical structure.

In a sixth aspect, alone or in combination with one or more of the first through fifth aspects, the beam link switch indication comprises a beam link switch request.

In a seventh aspect, alone or in combination with one or more of the first through sixth aspects, the beam link switch request indicates one or more of one or more causes associated with the beam link switch request, one or more target beams, or one or more time windows.

In an eighth aspect, alone or in combination with one or more of the first through seventh aspects, the beam link switch request comprises one or more of a MAC-CE or a RACH message.

In a ninth aspect, alone or in combination with one or more of the first through eighth aspects, the beam link switch indication comprises a beam link switch prediction message.

In a tenth aspect, alone or in combination with one or more of the first through ninth aspects, the beam link switch prediction message indicates one or more of one or more beam link switch predictions, one or more target beams, or one or more time points.

In an eleventh aspect, alone or in combination with one or more of the first through tenth aspects, the beam link switch prediction message comprises one or more of a MAC-CE or a RACH message.

In a twelfth aspect, alone or in combination with one or more of the first through eleventh aspects, the beam link switch indication comprises a beam link switch inference.

In a thirteenth aspect, alone or in combination with one or more of the first through twelfth aspects, the beam link switch inference indicates one or more of one or more beam link switch inference features, one or more ingredients or weights, metadata associated with the beam link switch inference, or one or more time stamps associated with the beam link switch inference.

In a fourteenth aspect, alone or in combination with one or more of the first through thirteenth aspects, the beam link switch inference comprises one or more of a control message or a data message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-8C. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a beam link switch configuration that indicates one or more beam link switch parameters associated with a plurality of beam link switch types. The transmission component 1104 may transmit, based at least in part on one or more beam link switch types of the plurality of beam link switch types, a beam link switch indication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5-8C. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a beam link switch configuration that indicates one or more beam link switch parameters associated with a plurality of beam link switch types. The reception component 1202 may receive, based at least in part on one or more beam link switch types of the plurality of beam link switch types, a beam link switch indication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving a beam link switch configuration that indicates one or more beam link switch parameters associated with a plurality of beam link switch types; and transmitting, based at least in part on one or more beam link switch types of the plurality of beam link switch types, a beam link switch indication.

Aspect 2: The method of Aspect 1, wherein the beam link switch indication is based at least in part on an artificial intelligence or machine learning (AI/ML) inference or prediction.

Aspect 3: The method of any of Aspects 1-2, wherein a beam link switch type of the plurality of beam link switch types is associated with intra-group beam switching associated with a selected synchronization signal block (SSB).

Aspect 4: The method of any of Aspects 1-3, wherein a beam link switch type of the plurality of beam link switch types is associated with inter-group beam switching associated with multiple selected synchronization signal blocks (SSBs).

Aspect 5: The method of any of Aspects 1-4, wherein a beam link switch type of the plurality of beam link switch types is associated with inter-cell beam switching.

Aspect 6: The method of any of Aspects 1-5, wherein the beam link switch configuration comprises a hierarchical structure.

Aspect 7: The method of any of Aspects 1-6, wherein the beam link switch indication comprises a beam link switch request.

Aspect 8: The method of Aspect 7, wherein the beam link switch request indicates one or more of one or more causes associated with the beam link switch request, one or more target beams, or one or more time windows.

Aspect 9: The method of Aspect 7, wherein the beam link switch request comprises one or more of a medium access control (MAC) control element (MAC-CE) or a random access channel (RACH) message.

Aspect 10: The method of any of Aspects 1-9, wherein the beam link switch indication comprises a beam link switch prediction message.

Aspect 11: The method of Aspect 10, wherein the beam link switch prediction message indicates one or more of one or more beam link switch predictions, one or more target beams, or one or more time points.

Aspect 12: The method of Aspect 10, wherein the beam link switch prediction message comprises one or more of a medium access control (MAC) control element (MAC-CE) or a random access channel (RACH) message.

Aspect 13: The method of any of Aspects 1-12, wherein the beam link switch indication comprises a beam link switch inference.

Aspect 14: The method of Aspect 13, wherein the beam link switch inference indicates one or more of one or more beam link switch inference features, one or more ingredients or weights, metadata associated with the beam link switch inference, or one or more time stamps associated with the beam link switch inference.

Aspect 15: The method of Aspect 13, wherein the beam link switch inference comprises one or more of a control message or a data message.

Aspect 16: A method of wireless communication performed by a network node, comprising: transmitting a beam link switch configuration that indicates one or more beam link switch parameters associated with a plurality of beam link switch types; and receiving, based at least in part on one or more beam link switch types of the plurality of beam link switch types, a beam link switch indication.

Aspect 17: The method of Aspect 16, wherein the beam link switch indication is based at least in part on an artificial intelligence or machine learning (AI/ML) inference or prediction.

Aspect 18: The method of any of Aspects 16-17, wherein a beam link switch type of the plurality of beam link switch types is associated with intra-group beam switching associated with a selected synchronization signal block (SSB).

Aspect 19: The method of any of Aspects 16-18, wherein a beam link switch type of the plurality of beam link switch types is associated with inter-group beam switching associated with multiple selected synchronization signal blocks (SSBs).

Aspect 20: The method of any of Aspects 16-19, wherein a beam link switch type of the plurality of beam link switch types is associated with inter-cell beam switching.

Aspect 21: The method of any of Aspects 16-20, wherein the beam link switch configuration comprises a hierarchical structure.

Aspect 22: The method of any of Aspects 16-21, wherein the beam link switch indication comprises a beam link switch request.

Aspect 23: The method of Aspect 22, wherein the beam link switch request indicates one or more of one or more causes associated with the beam link switch request, one or more target beams, or one or more time windows.

Aspect 24: The method of Aspect 22, wherein the beam link switch request comprises one or more of a medium access control (MAC) control element (MAC-CE) or a random access channel (RACH) message.

Aspect 25: The method of any of Aspects 16-24, wherein the beam link switch indication comprises a beam link switch prediction message.

Aspect 26: The method of Aspect 25, wherein the beam link switch prediction message indicates one or more of one or more beam link switch predictions, one or more target beams, or one or more time points.

Aspect 27: The method of Aspect 25, wherein the beam link switch prediction message comprises one or more of a medium access control (MAC) control element (MAC-CE) or a random access channel (RACH) message.

Aspect 28: The method of any of Aspects 16-27, wherein the beam link switch indication comprises a beam link switch inference.

Aspect 29: The method of Aspect 28, wherein the beam link switch inference indicates one or more of one or more beam link switch inference features, one or more ingredients or weights, metadata associated with the beam link switch inference, or one or more time stamps associated with the beam link switch inference.

Aspect 30: The method of Aspect 28, wherein the beam link switch inference comprises one or more of a control message or a data message.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one. ”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a beam link switch configuration that indicates one or more beam link switch parameters associated with a plurality of beam link switch types; and transmit, based at least in part on one or more beam link switch types of the plurality of beam link switch types, a beam link switch indication.

2. The apparatus of claim 1, wherein the beam link switch indication is based at least in part on an artificial intelligence or machine learning (AI/ML) inference or prediction.

3. The apparatus of claim 1, wherein a beam link switch type of the plurality of beam link switch types is associated with intra-group beam switching associated with a selected synchronization signal block (SSB).

4. The apparatus of claim 1, wherein a beam link switch type of the plurality of beam link switch types is associated with inter-group beam switching associated with multiple selected synchronization signal blocks (SSBs).

5. The apparatus of claim 1, wherein a beam link switch type of the plurality of beam link switch types is associated with inter-cell beam switching.

6. The apparatus of claim 1, wherein the beam link switch configuration comprises a hierarchical structure.

7. The apparatus of claim 1, wherein the beam link switch indication comprises a beam link switch request.

8. The apparatus of claim 7, wherein the beam link switch request indicates one or more of one or more causes associated with the beam link switch request, one or more target beams, or one or more time windows.

9. The apparatus of claim 7, wherein the beam link switch request comprises one or more of a medium access control (MAC) control element (MAC-CE) or a random access channel (RACH) message.

10. The apparatus of claim 1, wherein the beam link switch indication comprises a beam link switch prediction message.

11. The apparatus of claim 10, wherein the beam link switch prediction message indicates one or more of one or more beam link switch predictions, one or more target beams, or one or more time points.

12. The apparatus of claim 10, wherein the beam link switch prediction message comprises one or more of a medium access control (MAC) control element (MAC-CE) or a random access channel (RACH) message.

13. The apparatus of claim 1, wherein the beam link switch indication comprises a beam link switch inference output.

14. The apparatus of claim 13, wherein the beam link switch inference indicates one or more of one or more beam link switch inference features, one or more ingredients or weights, metadata associated with the beam link switch inference, or one or more time stamps associated with the beam link switch inference.

15. The apparatus of claim 13, wherein the beam link switch inference comprises one or more of a control message or a data message.

16. An apparatus for wireless communication at a network node, comprising:
one or more memories; and
one or more processors, coupled to the one or more memories, configured to cause the network node to:
transmit a beam link switch configuration that indicates one or more beam link switch parameters associated with a plurality of beam link switch types; and
receive, based at least in part on one or more beam link switch types of the plurality of beam link switch types, a beam link switch indication.

17. The apparatus of claim 16, wherein the beam link switch indication is based at least in part on an artificial intelligence or machine learning (AI/ML) inference or prediction.

18. The apparatus of claim 16, wherein a beam link switch type of the plurality of beam link switch types is associated with intra-group beam switching associated with a selected synchronization signal block (SSB).

19. The apparatus of claim 16, wherein a beam link switch type of the plurality of beam link switch types is associated with inter-group beam switching associated with multiple selected synchronization signal blocks (SSBs).

20. The apparatus of claim 16, wherein a beam link switch type of the plurality of beam link switch types is associated with inter-cell beam switching.

21. The apparatus of claim 16, wherein the beam link switch configuration comprises a hierarchical structure.

22. The apparatus of claim 16, wherein the beam link switch indication comprises a beam link switch request.

23. The apparatus of claim 22, wherein the beam link switch request indicates one or more of one or more causes associated with the beam link switch request, one or more target beams, or one or more time windows.

24. The apparatus of claim 22, wherein the beam link switch request comprises one or more of a medium access control (MAC) control element (MAC-CE) or a random access channel (RACH) message.

25. The apparatus of claim 16, wherein the beam link switch indication comprises a beam link switch prediction message.

26. The apparatus of claim 25, wherein the beam link switch prediction message indicates one or more of one or more beam link switch predictions, one or more target beams, or one or more time points.

27. The apparatus of claim 25, wherein the beam link switch prediction message comprises one or more of a medium access control (MAC) control element (MAC-CE) or a random access channel (RACH) message.

28. The apparatus of claim 16, wherein the beam link switch indication comprises a beam link switch inference.

29. A method of wireless communication performed by a user equipment (UE), comprising:
receiving a beam link switch configuration that indicates one or more beam link switch parameters associated with a plurality of beam link switch types; and
transmitting, based at least in part on one or more beam link switch types of the plurality of beam link switch types, a beam link switch indication.

30. A method of wireless communication performed by a network node, comprising:
transmitting a beam link switch configuration that indicates one or more beam link switch parameters associated with a plurality of beam link switch types; and
receiving, based at least in part on one or more beam link switch types of the plurality of beam link switch types, a beam link switch indication.
